(19) United States
(12) Patent Application Publication
(10) Pub. No.: US 2010/0032489 A1
(43) Pub. Date: Feb. 11, 2010

(54) Environmental Testing Apparatus

(76) Inventor: Kun-Ta Lee, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/473,364

(22) Filed: May 28, 2009

(30) Foreign Application Priority Data
Aug. 6, 2008 (TW) 97214088

(51) Int. Cl. G05D 22/00

(52) U.S. Cl. 236/44 C

(57) ABSTRACT

An environmental test apparatus is disclosed. The environmental test apparatus is configured to simulate the environmental variation in temperature and humidity. The environmental test apparatus comprises a box, a plurality of openings, a plurality of fans and a plurality of controllers. The box has a plurality of side walls, wherein the openings are disposed on at least two side walls of the box, and each of the fans is correspondingly disposed in each of the openings. The controllers are configured to control the rotational speed of each fan and adapted to uniform the distribution of the temperature and the humidity inside the box.

This application claims priority to Taiwan Patent Application No. 097214088 filed on Aug. 6, 2008.

### CROSS-REFERENCES TO RELATED APPLICATIONS

Not applicable.

### BACKGROUND OF THE UTILITY

1. Field of the Utility

The present utility provides an environmental testing apparatus. More specifically, the present utility provides an environmental testing apparatus for temperature and humidity tests.

2. Descriptions of the Related Art

With the thriving development of various electronic products, reliability tests of electronic products have attracted significant attention. Accordingly, environmental tests for simulating the operating conditions of electronic products in different environments have also become more important. Environment tests can be accomplished by using an environmental testing apparatus to simulate variations in temperature and humidity of a test object in different environments. Generally, the environmental testing apparatus comprises a hollow box where the operator can place the test object. The operator can observe the performance of the test object under preset environment conditions for evaluation. Therefore, if the environmental testing apparatus fails to correctly simulate the desired environment, considerable impact would be imposed on the test results of the test object, thereby decreasing the functional accuracy of the evaluation products.

FIG. 1 illustrates a schematic view of a conventional environmental testing apparatus 1 for temperature and humidity tests. The environmental testing apparatus 1 comprises a hollow box 11, an air inlet 13a, a fan 13b disposed in the air inlet 13a, an air outlet 13c, a fan 13d disposed in the air outlet 13c and a controller 15. The hollow box 11 has a plurality of side walls, for example, a left side wall 17 and a right side wall 13. The controller 15 is configured to control the rotational speeds of the fans 13b, 13d. In other words, the rotational speeds of the fans 13b, 13d are set to be the same by the controller 15. Conventionally, the air inlet 13a, the air outlet 13c and the fans 13b, 13d are disposed at different locations only on one of the side walls, for example, only on the right side wall 13.

As shown in FIG. 1, the environmental testing apparatus 1 is configured to evaluate the reliability of the test object 19 by simulating different temperatures and humidity levels. During operation, because the air inlet 13a, the air outlet 13c, and the fans 13b, 13d of the conventional environmental testing apparatus 1 are all located on a single side wall 13, the air flow outputted from the air inlet 13a often fails to be distributed uniformly inside the hollow box 11. In more detail, as indicated by the arrow in FIG. 1, because the air flow outputted from the air inlet 13a is obstructed by the test object 19 itself and the air outlet 13c is disposed on the same side wall 13 above the air inlet 13a, the air flow near the side wall 17 inside the hollow box 11 is not so strong as that near the side wall 13, which results in non-uniform temperature and humidity distribution inside the environmental testing apparatus 1. Therefore, the environmental testing apparatus 1 has an adverse effect on test results.

Accordingly, it is highly desirable in the art to improve the reliability of the testing results that may be decreased when there is a non-uniform distribution of air flow in conventional environmental testing apparatuses.

### SUMMARY OF THE UTILITY

One objective of this utility is to provide an environmental testing apparatus adapted to uniform the temperature and humidity distribution inside the hollow box.

Another objective of this utility is to provide an environmental testing apparatus capable of controlling rotational speeds of air fans individually.

To achieve above objectives, the environmental testing apparatus disclosed in this utility comprises a hollow box, a plurality of openings, a plurality of fans, and at least one controller. The hollow box has a plurality of side walls, with the plurality of openings disposed separately on at least two of the side walls of the hollow box. Each fan is disposed in each of the openings respectively, while the at least one controller is configured to control a rotational speed of each fan individually. Accordingly, with multiple air flow directions, multiple openings as well as the ability of the at least one controller to control the rotational speed of each fan individually, the temperature and the humidity inside the environmental testing apparatus can be uniform to improve the accuracy of the environmental simulation tests.

The detailed technology and preferred embodiments implemented for the subject utility are described in the following paragraphs accompanying the appended drawings for people skilled in this field to well appreciate the features of the claimed utility.

### BRIEF DESCRIPTION OF THE DRAWINGS

FIG. 1 is a schematic view of a conventional environmental testing apparatus; and

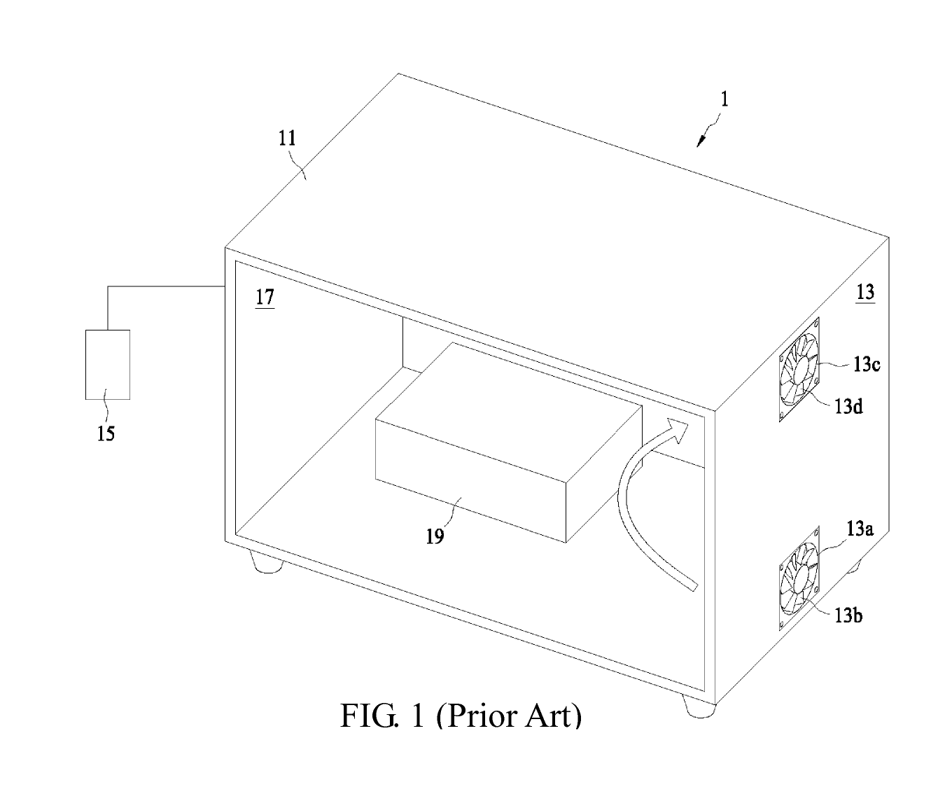

FIG. 2 is a schematic view of an embodiment of this utility.

### DESCRIPTION OF THE PREFERRED EMBODIMENT

It should be noted that in the following embodiments and the attached drawings, elements unrelated to this utility are omitted from depiction. Directions, dimensional scales shown in the embodiments and the attached drawings are provided only for purpose of illustration and not limitation. For ease of understanding, dimensional relationships among individual elements are depicted on an exaggerative scale.

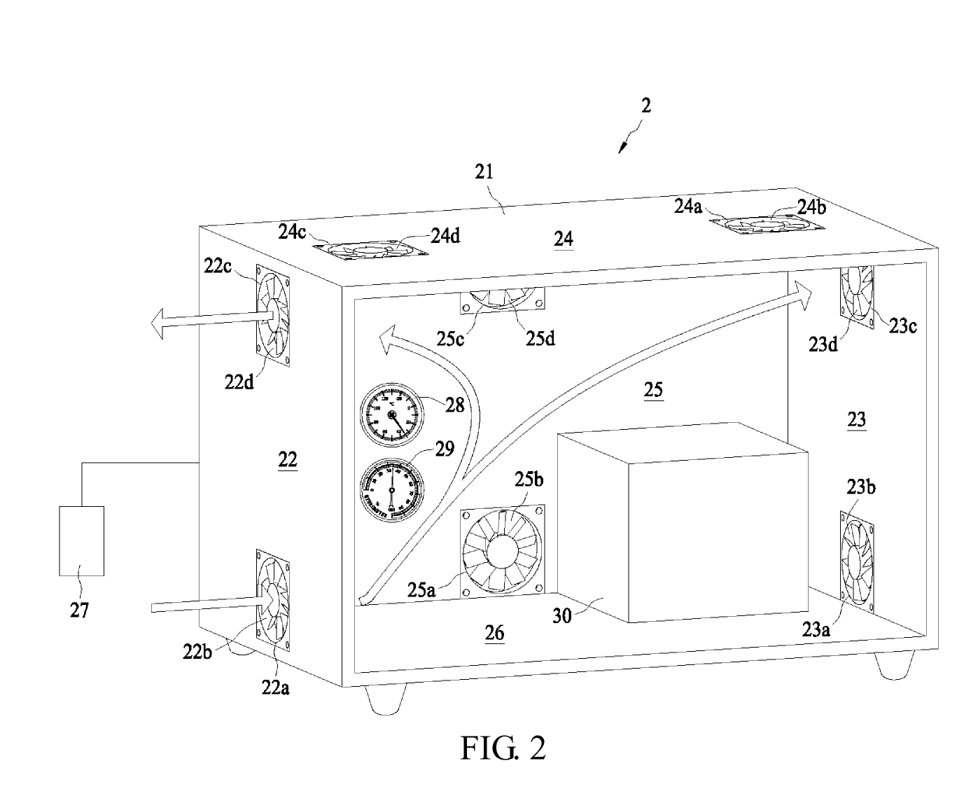

FIG. 2 is a schematic view of an environmental testing apparatus 2 of this utility. The environmental testing apparatus 2 comprises a hollow box 21, a plurality of openings 22a, 22c, 23a, 23c, 24a, 24c, 25a, 25c, a plurality of fans 22b, 22d, 23b, 23d, 24b, 24d, 25b, 25d, at least one controller 27, a thermometer 28 and a hygrometer 29. The fans 22b, 22d, 23b, 23d, 24b, 24d, 25b, 25d are disposed correspondingly in the openings 22a, 22c, 23a, 23c, 24a, 24c, 25a, 25c respectively. The controller 27 has a plurality of control units configured to control a rotational speed and a fan blade rotational direction of each of the fans 22b, 22d, 23b, 23d, 24b, 24d, 25b, 25d respectively. That is, the controller 27 may control each fan to rotate in the clockwise direction or the counterclockwise direction depending on the practical needs so that each of the corresponding openings can function as an air inlet or an air outlet. It should be appreciated that the number of fans and openings set forth in this embodiment is only provided for purpose of description and not limitation, and those of ordinary skill in the art may readily apply this utility to environmental simulation apparatuses with another number of fans and openings upon reviewing the following description.

It should be noted that the hollow box 21 of this utility has a plurality of side walls 22, 23, 24, 25, 26 adapted to receive the test object 30. In this embodiment, the hollow box 21 has a cubic profile; however, it can be appreciated that the hollow box 21 may also be designed as a container with a different profile and a different outline depending on practical needs.

One characteristic of this utility is that the openings 22a, 22c, 23a, 23c, 24a, 24c, 25a, 25c are disposed on at least two opposite or adjacent side walls of the hollow box 21 respectively. For example, in this embodiment, the openings 22a, 22c are disposed on the side wall 22, the openings 23a, 23c are disposed on the side wall 23, the openings 24a, 24c are disposed on the side wall 24, and the openings 25a, 25c are disposed on the side wall 25 of the hollow box 21, thereby, creating a uniform flow field inside the environmental testing apparatus of this utility. It should be noted that in other examples, the openings may be disposed differently on the side walls 22, 23, 24, 25, 26 depending on the number of openings.

Furthermore, because the environmental testing apparatus 2 of this embodiment is able to adjust the rotational speed and the blade direction of each fan 22b, 22d, 23b, 23d, 24b, 24d, 25b, 25d respectively by the controller 27, each of the openings 22a, 22c, 23a, 23c, 24a, 24c, 25a, 25c can function as either an air inlet or an air outlet depending on practical needs. Therefore, this environmental testing apparatus 2 allows the user to adjust the rotational speed and direction of each fan according to a shape of the test object 30 received in the hollow box 21, thereby, improving the uniformity of the flow field therein and accurately simulate environmental conditions in various tests.

In addition, to illustrate how to make the flow field inside the hollow box 21 uniform, a method for controlling the air flow inside the box of this embodiment will be described with the side walls 22, 23 as an example. As indicated by the arrows in FIG. 2, when the test object 30 is placed in the hollow box 21, the air introduced by the air inlet 22a can flow towards the air outlet 22c. Furthermore, to mitigate the phenomenon of non-uniformity distribution of the temperature and humidity caused by the obstruction of the test object 30, the controller 27 is capable of controlling the control unit of the fan 23d to increase the rotational speed of the fan 23d. Thereby, the present invention smoothly guides the flow field inside the box towards the side wall 23. In this way, the non-uniformity of temperature and humidity distribution inside the hollow box 21 of the prior art by disposing the openings on a single side wall is improved. Similarly, the openings 23a, 23c, 24a, 24c, 25a, 25c on the side walls 23, 24, 25 of the hollow box 21 are also controlled by similar flow mechanisms to fully improve the accuracy of the environmental testing apparatus in simulating the flow field.

Additionally, in a preferred embodiment of this utility, at least one thermometer 28 and at least one hygrometer 29 may be further provided to assist in determining the distribution of the temperature and humidity inside the hollow box 21. In more detail, by using measurement results from the thermometer 28 and the hygrometer 29 as a basis to adjust the rotational speed and/or rotational direction of each fan, the controller 27 adjusts the test environment to the desired environmental conditions to enhance the uniformity of the flow field distribution.

According to the above descriptions, by disposing a plurality of openings on at least two side walls of the hollow box 21 to provide more air inlet/outlet directions and by using the controller 27 to adjust the rotational speed and/or direction of each fan individually according to the measurement values of the temperature and humidity, the environmental testing apparatus 2 overcomes the shortcoming of the non-uniformly distributed of temperature and humidity inside the hollow box 21 due to the restricted coverage of the flow field.

The above disclosure is related to the detailed technical contents and inventive features thereof. People skilled in this field may proceed with a variety of modifications and replacements based on the disclosures and suggestions of the utility as described without departing from the characteristics thereof. Nevertheless, although such modifications and replacements are not fully disclosed in the above descriptions, they have substantially been covered in the following claims as appended.

What is claimed is:

1. An environmental testing apparatus being configured to simulate the environmental variation in temperature and humidity, the environmental testing apparatus comprising:
a hollow box, having a plurality of side walls;
a plurality of openings, being disposed on at least two side walls of the hollow box;
a plurality of fans, being disposed in each opening respectively; and
at least one controller, being configured to control a rotational speed of each of the plurality of fans to uniform the temperature and the humidity inside the hollow box.

2. The environmental testing apparatus of claim 1, wherein the hollow box is a cubic.

3. The environmental testing apparatus of claim 1, wherein the openings comprise at least one inlet and at least one outlet.

4. The environmental testing apparatus of claim 3, wherein the at least one inlet and the at least one outlet are disposed on side walls that are opposite to each other.

5. The environmental testing apparatus of claim 1, further comprising:
at least one thermometer, being configured to show the temperature inside the hollow box.

6. The environmental testing apparatus of claim 1, further comprising at least one hygrometer, being configured to show the humidity inside the hollow box.
